(19) United States
(12) Patent Application Publication
(10) Pub. No.: US 2019/0069365 A1
(43) Pub. Date: Feb. 28, 2019

(54) SYSTEM AND METHOD FOR COLLECTING MAXIMUM DIMMING PARAMETER OF A LAMP GROUP WITH A RATED CURRENT UNKNOWN

(71) Applicants: Wanjiong Lin, NINGBO (CN); Self Electronics Co., Ltd., Ningbo (CN); Self electronics USA Corporation, Norcross, GA (US)

(72) Inventor: Dong Wu, NINGBO (CN)

(73) Assignees: Wanjiong Lin; Self Electronics Co., Ltd.; Self Electronics USA Corp.

(21) Appl. No.: 16/057,315

(22) Filed: Aug. 7, 2018

(30) Foreign Application Priority Data
Aug. 25, 2017 (CN) 201710738725.4

(51) Int. Cl. H05B 33/08

(52) U.S. Cl. CPC H05B 33/0845

(57) ABSTRACT

A system and method for collecting maximum dimming parameters of a lamp group with an unknown rated current includes a lamp operating at a constant voltage or a plurality of lamps connected in parallel. A dimming preset limit parameter and rated voltage preset module, an actual parameter value collecting module, a judgment module, an operating mode switching module, a limit parameter working module, an actual dimming parameter value collecting module, and a maximum dimming parameter and dimming preset parameter value assignment module are present. The system can timely collect the maximum dimming parameter value of the lamp group with a variable or unknown rated current, dimming is effective at any time in the full-scale range, and the dead zone phenomenon if the dimming parameter value is greater than the dimming range of 70% or 50% is reduced.

### CROSS-REFERENCE TO A RELATED APPLICATION

This application claims priority to a Chinese Patent Application No. CN 201710738725.4, filed on Aug. 25, 2017.

### FIELD OF THE TECHNOLOGY

The present invention relates to the power supply for LED lamps, with particular emphasis on a system and method for collecting maximum dimming parameters of a lamp group with a rated current unknown.

### BACKGROUND

In everyday life, you can see all kinds of lighting equipment everywhere, for examples, fluorescent lamps, street lamps, table lamps, art lamps and so on. All above of the lighting equipment, the tungsten filament bulb has been traditionally used as a light source for illumination. In recent years, the light-emitting diode (LED) has been utilized as light-emitting sources due to the rapid advances in technology. In addition to lighting equipment, the light source of general traffic signs, billboards, Headlights and the like are also replaced by light-emitting diodes. As mentioned above, the use of light-emitting diodes as a light source has the advantages of power saving and greater brightness, and thus has become more and more common in use.

With the popularity of LED lamps, LED lamps are used in more and more occasions, but as we all know, LED lamps are powered by a dedicated LED power supply. At the same time, with the improvement of living standard, people need the LED lamp with variable brightness output, therefore, the LED power supply with variable output power is needed. In the prior art, there is a variety of LED power supplies with variable output power that can change the output brightness of the LED lamp. However, these LED power supplies in some cases do not give users a very good experience of using light, for example, display lighting, In the museum, many users prefer to use a mobile phone or a camera to photograph the displayed items. However, the existing LED power supply with variable output power makes the light source provided by the LED lamp often form a lot of photos taken by the mobile phone or the camera Streaks, so-called “blinks,” distort the photos, affecting the user's light experience.

In the prior art, it can avoid the phase flash by adjusting the current to adjust the brightness of the LED lamp, this method is suitable for a constant current lamp or lamp group, not for a constant current of unknown value flowing through a lamp or lamp group, such as in a freezer or showcase, the customer does not know how many lamps to make up a lamp group, but only wants to use a constant voltage dimming power supply, thus causing the current through the lamp system to be unknown. If you also use the existing constant current dimming power supply, the maximum dimming current is often constant, which makes the output of the lamp has reached the brightest when the dimmer is adjusted to 70% or 50% or other range, that is, not full range, the remaining 30% or 50% or more of the dimming margin is redundant, invalid, it will reduce the user's lighting experience. The leading cause of the above phenomenon is that it is difficult for the dimming power supply to determine the maximum current of the lamp group whose rated current is unknown.

### SUMMARY OF THE INVENTION

Therefore, It is necessary to provide a system for collecting maximum dimming current of a lamp group with a rated current unknown which can timely collect the maximum dimming current of the lamp group in use so as to solve the above problem.

a system for collecting maximum dimming parameters of a lamp group with a rated current unknown, the lamp group includes one lamp operating at a constant voltage or a plurality of lamps connected in parallel, comprising: a dimming limit parameter and the rated voltage preset module 10, an actual dimming parameter value collection module 20, a judgment module 30, a operating mode switch module 40, a limit parameter working module 50, an actual parameter value collection module 60, and a maximum dimming parameter and a dimming preset parameter value assignment module 70, the actual dimming parameter value collection module 20 is configured to collect the actual dimming parameter value Dₐ actually loaded into the lamp group with a rated current unknown; the judgment module 30 is configured to judge whether the actual dimming parameter value Dₐ is equal to a full-scale dimming parameter value Dₘₐₓ; the operating mode switching module 40 is configured to make the lamp group with a rated current unknown work at a rated voltage when Dₐ is equal to Dₘₐₓ; the limit parameter working module 50 is configured to make the lamp group with a rated current unknown work at the dimming preset limit parameter Pₗᵢₘᵢₜ when the Dₐ is smaller than Dₘₐₓ; the actual parameter value collection module 60 is configured to collect the parameter value Pₛₑₙ of the lamp group with a rated current unknown when Dₐ is equal to Dₘₐₓ; the maximum dimming parameter and dimming preset parameter value assignment module 70 is configured to assign the product of the parameter value Pₛₑₙ and the actual dimming parameter value Dₐ to the maximum dimming parameter value P_{ref} and assign the maximum dimming parameter value P_{ref} to the dimming preset limit parameter Pₗᵢₘᵢₜ when Dₐ is equal to Dₘₐₓ, and also, to assign the dimming preset limit parameter Pₗᵢₘᵢₜ to the maximum dimming parameter value P_{ref} when Dₐ is smaller than Dₘₐₓ.

Advantageously, when the maximum dimming current parameter system and the lamp set with the rated current are electrically connected for the first time, the actual dimming parameter value Dₐ is set to the dimming maximum range value Dₘₐₓ.

Advantageously, the preset rated voltage is 24V.

Advantageously, before using the maximum dimming parameter collecting system, the total power of the lamp group with rated current unknown is unknown.

Advantageously, the system 100 for collecting the maximum dimming parameter of a lamp group with a rated current unknown and the lamp group with unknown rated current are electrically connected for the first time, when the total power of the lamp group with the rated current unknown is reduced, the lamp group with the rated current unknown will be started at the maximum dimming parameter value I_{ref} collected for the first time.

Advantageously, the system 100 for collecting the maximum dimming parameter of a lamp group with a rated current unknown and the lamp group with unknown rated current are electrically connected for the first time, when the total power of the lamp group with the rated current unknown increases, the lamp group with the rated current unknown operates at the preset rated voltage.

Advantageously, the lamp groups with rated current unknown operate at a constant voltage.

A method for collecting maximum dimming parameters of a lamp group with a rated current unknown, comprising the following steps: provide a dimming preset limit parameter and rated voltage preset module 10, the dimming preset limit parameter and rated voltage preset module 10 is configured to preset the value of the dimming preset limit parameter Pₗᵢₘᵢₜ and the rated voltage value when the system 100 for collecting the maximum dimming parameter of a lamp group with a rated current unknown is electrically connected with the lamp group with a rated current unknown for the first time; provide an actual dimming parameter value collection module 20, the actual dimming parameter value collection module 20 is configured to collect the actual dimming parameter value Dₐ actually loaded into the lamp group with a rated current unknown; provide a judgment module 30, the judgment module 30 is configured to judge whether the actual dimming parameter value Dₐ is equal to a full-scale dimming parameter value Dₘₐₓ; provide an operating mode switching module 40 for making the lamp group with a rated current unknown work at a rated voltage when Dₐ is equal to Dₘₐₓ; provide a limit parameter working module 50 for making the lamp group with a rated current unknown work at the dimming preset limit parameter Pₗᵢₘᵢₜ when the Dₐ is smaller than Dₘₐₓ; provide an actual parameter value collection module 60 for collecting the parameter value Pₛₑₙ of the lamp group with a rated current unknown when Dₐ is equal to Dₘₐₓ; and provide a maximum dimming parameter and dimming preset parameter value assignment module 70 to assign the product of the parameter value Pₛₑₙ and the actual dimming parameter value Da to the maximum dimming parameter value P_{ref} and assign the maximum dimming parameter value P_{ref} to the dimming preset limit parameter Pₗᵢₘᵢₜ when Dₐ is equal to Dₘₐₓ, and also, to assign the dimming preset limit parameter Pₗᵢₘᵢₜ to the maximum dimming parameter value P_{ref} when Dₐ is smaller than Dₘₐₓ.

Compared with the prior art, since the system 100 for collecting the maximum dimming parameter of a lamp group with a rated current unknown provided by the present invention can timely collect the maximum dimming parameter value P_{ref} of the lamp group with a rated current unknown or varied, so that at any time in the full-scale range dimming is effective, and will not cause the dead zone phenomenon if the dimming parameter value is greater than the dimming range of 70% or 50% of, thereby increasing the user's light experience.

### DETAILED DESCRIPTION OF THE DRAWINGS

The drawings described herein are intended to promote a further understanding of the present invention, as follows:

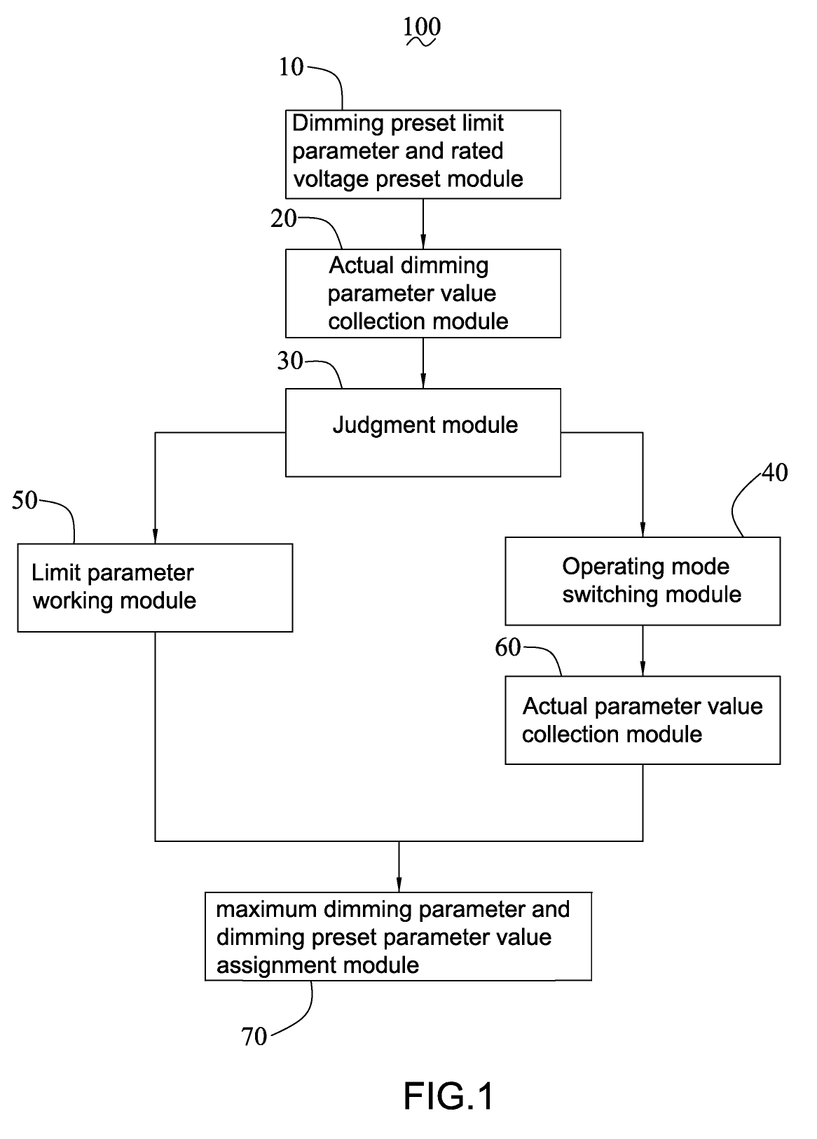

FIG. 1 is a schematic block diagram of a system for collecting maximum dimming parameters of a lamp group with a rated current unknown provided by the present invention.

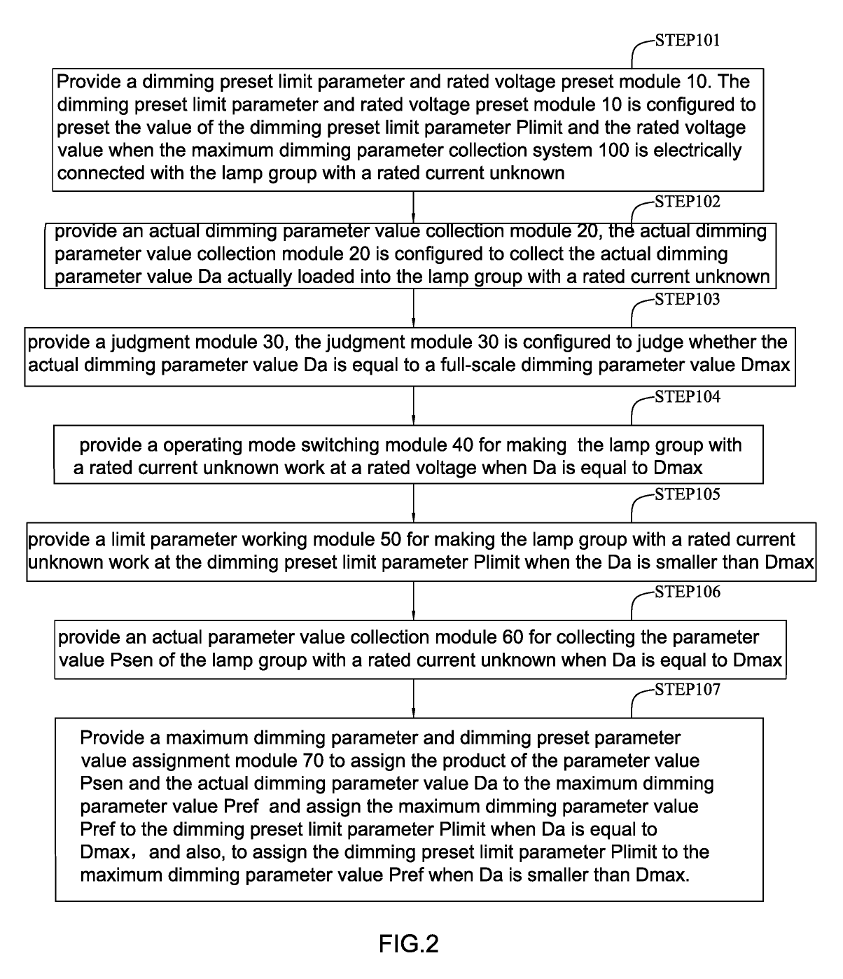

FIG. 2 is an application circuit diagram of the system for collecting maximum dimming parameters of a lamp group with a rated current unknown of FIG. 1.

### DESCRIPTION OF THE PREFERRED EMBODIMENTS

The present application is illustrated by way of the following detailed description based on of the accompanying drawings. It should be noted that illustration to the embodiment in this application is not intended to limit the invention.

Please referring to FIG. 1 to FIG. 2, which are a schematic block diagram of the system for collecting maximum dimming parameters of a lamp group with a rated current unknown provided by the present invention. The system for collecting maximum dimming parameters of a lamp group with a rated current unknown comprises a dimming limit parameter and the rated voltage preset module 10, an actual dimming parameter value collection module 20, a judgment module 30, a operating mode switch module 40, a limit parameter working module 50, an actual parameter value collection module 60, and a maximum dimming parameter and a dimming preset parameter value assignment module 70. It is conceivable that the system 100 for collecting the maximum dimming parameter of a lamp group with a rated current unknown further comprises other functional modules, such as a data processing module, a data transmission module, and the like, which should be known to those skilled in the art, and no longer here describe it in details. It should be noted that, each of the foregoing functional modules, namely, the dimming preset limit parameter and the rated voltage preset module 10, the actual dimming parameter value collection module 20, the judgment module 30, the operating mode switching module 40, the limit parameter working module 50, The actual parameter value collection module 60, and the maximum dimming parameter and the dimming preset parameter value assignment module 70 are electrically connected together and perform logical operations through data transmission, and the functions of the above modules can be implemented by a microcontroller, a microprocessor, or a circuit composed of ordinary electronic components such as diodes and transistors, which are not described in detail herein. In addition, the execution program of the foregoing functional module should also be implemented by those skilled in the art based on the idea of the present invention using existing computer languages such as VB, VC and the like. The group of lamps whose rated current is unknown may include one independent lamp or may be connected in parallel for a plurality of independent lamps so as to form the lamp group. In this parallel mode, a plurality of lamps can be connected in parallel, the number of lamps and the total power is not constant, and the lamp group with the rated current unknown is operated at a constant voltage. However, the user does not know how many lamps a light field needs before using, that is, the number of lamps that make up the lamp group is not certain. That is, before using the system for collecting the maximum dimming parameter of a lamp group with a rated current unknown, the total power of the lamp group with the rated current unknown is unknown, but the factory designs or manufactures the following dimmable power supply. If the total power of the lamp group is known, that is, the number of lamp group is known then the maximum dimming current will also be known, then the system 100 for collecting the maximum dimming parameter of a lamp group with a rated current unknown is no longer needed to determine the maximum dimming parameter.

It should be further explained that, because the ultimate goal of the system 100 for collecting the maximum dimming parameter of a lamp group with a rated current unknown is to dimming the lamp group with the rated current unknown, the dimming is performed by a dimming power supply. Therefore, the system 100 for collecting the maximum dimming parameter of a lamp group with a rated current unknown is usually integrated in the dimming power supply. When the dimming power supply is connected with the lamp group, the system 100 for collecting the maximum dimming parameter of a lamp group with a rated current unknown is also electrically connected with the lamp group. At the same time, the data of the system 100 for collecting the maximum dimming parameter of a lamp group with a rated current unknown is derived from the dimming power supply, and the system 100 for collecting the maximum dimming parameter of a lamp group with a rated current unknown is also applied to the dimming power supply for dimming. Therefore, the technical terms used in the present invention should all be understood by those skilled in the art, and need not be described in further detail.

The dimming preset limit parameter and rated voltage preset module 10 is configured to preset the value of the dimming preset limit parameter Pₗᵢₘᵢₜ and the rated voltage value when the system 100 for collecting the maximum dimming parameter of a lamp group with a rated current unknown is electrically connected with the lamp group with a rated current unknown for the first time. Before the dimming power source integrated with the system 100 for collecting the maximum dimming parameter of a lamp group with a rated current unknown is not connected to the lamp group, the system 100 for collecting the maximum dimming parameter of a lamp group with a rated current unknown should preset the dimming preset limit parameter Pₗᵢₘᵢₜ and the rated voltage value when the dimming power supply is electrically connected to the lamp group for the first time, the lamp group is allowed to operate under the preset dimming limit parameter Pₗᵢₘᵢₜ or the rated voltage value. The dimming preset limit parameter Pₗᵢₘᵢₜ or the rated voltage value may be any value, but for the LED lamp set, the nominal voltage may be 12V, 24V, and 36V, and the like, and the rated voltage is a nominal parameter, Anyone can know. In the present embodiment, the rated voltage is 24V, that is, the rated voltage of each lamp in the group of lamps or lamps electrically connected to the system 100 for collecting the maximum dimming parameter of a lamp group with a rated current unknown is 24V. The preset dimming preset limit parameter Pₗᵢₘᵢₜ may be a current value, a voltage value corresponding to the current value, a binary 1 or 0 defined by the user corresponding to the current value or the voltage value, even other variables. In this embodiment, the dimming preset limit parameter Pₗᵢₘᵢₜ is a current value.

The actual dimming parameter value collection module 20 is configured to collect the actual dimming parameter value Dₐ actually loaded into the lamp group with a rated current unknown. After the dimming power source integrated with the system 100 for collecting the maximum dimming parameter of a lamp group with a rated current unknown is electrically connected to the lamp group, the system 100 for collecting the maximum dimming parameter of a lamp group with a rated current unknown first compares the actual dimming parameter value Dₐ loaded on the lamp group Collect. Of course, it can be understood that the actual dimming parameter Dₐ is also output by the dimming power supply and applied to the current or the voltage of the lamp group flowing through the lamp whose rated current is unknown.

The judgment module 30 is configured to judge whether the actual dimming parameter value Dₐ is equal to a full-scale dimming parameter value Dₘₐₓ. Dimming parameter value is usually a percentage, for example, dimming power supply 1-10V, 10V represents 100% of the output, that is, according to the maximum dimming current output, 1V represents 0%, that is, there is no output, that is, there is no current Output. Dimming 1-10V power supply is the mainstream power supply dimming power, but also the market dimming conventions.

The operating mode switching module 40 is configured to make the lamp group with a rated current unknown work at a rated voltage when Dₐ is equal to Dₘₐₓ. When Dₐ is equal to Dₘₐₓ, the group of lamps with the rated current unknown should work under the maximum dimming parameter. In this embodiment, the group of lamps with the rated current unknown should be operated under the maximum dimming current. Therefore, the voltage applied to the lamp group should be the rated voltage. Correspondingly, the lamp group will also work at the maximum current, ie, the maximum brightness and other parameters.

The limit parameter working module 50 is configured to make the lamp group with a rated current unknown work at the dimming preset limit parameter Pₗᵢₘᵢₜ when the Dₐ is smaller than Dₘₐₓ. It can be understood that when Dₐ is smaller than Dₘₐₓ, the group of lamps whose rated current is unknown should not work under the maximum dimming parameter. In this embodiment, the group of lamps whose rated current is unknown is not operated under the maximum dimming current, but also do not know the maximum current dimming current of the lamp group, in short, it is not working at rated voltage. If the lamp groups with the rated current unknown work under the rated voltage, Dₐ should be equal to Dₘₐₓ. Therefore, the lamp group with the rated current unknown is operated under the preset dimming limit parameter Pₗᵢₘᵢₜ, that is, the dimming preset limit current is operated, and then the system 100 for collecting the maximum dimming parameter of a lamp group with a rated current unknown is used to collect the maximum dimming parameter value of the lamp group with the rated current unknown.

The actual parameter value collection module 60 is configured to collect the parameter value Pₛₑₙ of the lamp group with a rated current unknown when Dₐ is equal to Dₘₐₓ. In this embodiment, the current value is collected. It is conceivable that the parameter value Pₛₑₙ currently flowing should also be the maximum parameter value flowing through the lamp group since it is operated at the rated voltage. Therefore, it can be understood that the current maximum dimming parameter is the product of Dₐ and Pₛₑₙ.

The maximum dimming parameter and dimming preset parameter value assignment module 70 is configured to assign the product of the parameter value Pₛₑₙ and the actual dimming parameter value Da to the maximum dimming parameter value P_{ref} and assign the maximum dimming parameter value P_{ref} to the dimming preset limit parameter Pₗᵢₘᵢₜ when Dₐ is equal to Dₘₐₓ, and also, to assign the dimming preset limit parameter Pₗᵢₘᵢₜ to the maximum dimming parameter value P_{ref} when Dₐ is smaller than Dₘₐₓ. Based on the above description, when Dₐ is equal to Dₘₐₓ, the lamp group with the rated current unknown will work at the rated voltage, and the parameter value Pₛₑₙ flowing through the lamp group is the maximum parameter value flowing through the lamp group, and therefore The maximum dimming parameter value is the product of Dₐ and Pₛₑₙ, so the product of Dₐ and Iₛₑₙ can be assigned to the maximum dimming parameter value P_{ref}. In the subsequent dimming, ie, taking the maximum dimming parameter value P_{ref} as a reference, the product of the maximum dimming parameter and the input dimming parameter is the dimming parameter output by the dimming power supply. Because Pₛₑₙ is collected from the lamp groups whose rated current is unknown, this Pₛₑₙ corresponds to the current lamp group and is dynamic and variable. Therefore, the dimming parameters are also different according to the rated current of the lamp group, so that full-scale dimming parameters will work. When Dₐ is smaller than Dₘₐₓ, the lamp group with the rated current unknown works under the dimming preset limit parameter Pₗᵢₘᵢₜ, and then the maximum dimming parameter of the current lamp group is the dimming preset limit parameter Pₗᵢₘᵢₜ, so that the dimming preset limit parameter Pₗᵢₘᵢₜ is assigned to the maximum dimming parameter Pref. In this case, when Dₐ continuously becomes smaller, the current applied to the lamp group is the product of the maximum dimming parameter P_{ref} and Da. Because the maximum dimming parameter P_{ref} is equal to the dimming preset limit parameter Pₗᵢₘᵢₜ, the dimming parameters in full-scale all play a role. In summary, the system 100 for collecting the maximum dimming parameter of a lamp group with a rated current unknown collects the maximum dimming parameter Pref. When the user adjusts Dₐ to make Dₐ continuously increase, once Dₐ is equal to Dₘₐₓ, the operating mode switching module 40 will work to make the lamp group with the rated current unknown work at the rated voltage, and then the maximum dimming parameter is adjusted to the value of the product of Dₐ and Pₛₑₙ.

Through the above detailed description, it is preferable that when the system 100 for collecting the maximum dimming parameter of a lamp group with a rated current unknown and the lamp group with unknown rated current are electrically connected for the first time, it is preferable for the user to set the actual dimming parameter value Dₐ to 100% Dimming range Dₘₐₓ, which can reduce the adjustment steps.

After the dimming power supply integrated with the system 100 for collecting the maximum dimming parameter of a lamp group with a rated current unknown is electrically connected for the first time with the lamp group with unknown rated current, the maximum dimming parameter I_{ref} is determined at this time. Then, when the total power of the lamp group with the rated current unknown is reduced, that is, the number of the lamps is reduced, after the reduction of the total power of the lamp group with the rated current unknown will be started at the maximum dimming parameter value I_{ref} collected for the first time, because the number of lamps is reduced, the total current value of the lamp in parallel decreases. On the contrary, when the total power of the lamp group with the rated current unknown increases, the lamp group with the rated current unknown operates at the preset rated voltage, when the total power is increased, at a constant voltage, the total current will increase.

Please refer to FIG. 2, a maximum dimming parameter collection method provided by the present invention, which comprises the following steps:

STEP 101: Provide a dimming preset limit parameter and rated voltage preset module 10. The dimming preset limit parameter and rated voltage preset module 10 is configured to preset the value of the dimming preset limit parameter Pₗᵢₘᵢₜ and the rated voltage value when the system 100 for collecting the maximum dimming parameter of a lamp group with a rated current unknown is electrically connected with the lamp group with a rated current unknown for the first time;

STEP 102: provide an actual dimming parameter value collection module 20, the actual dimming parameter value collection module 20 is configured to collect the actual dimming parameter value Dₐ actually loaded into the lamp group with a rated current unknown;

STEP 103: provide a judgment module 30, the judgment module 30 is configured to judge whether the actual dimming parameter value Dₐ is equal to a full-scale dimming parameter value Dₘₐₓ;

STEP 104: provide a operating mode switching module 40 for making the lamp group with a rated current unknown work at a rated voltage when Dₐ is equal to Dₘₐₓ;

STEP 105: provide a limit parameter working module 50 for making the lamp group with a rated current unknown work at the dimming preset limit parameter Pₗᵢₘᵢₜ when the Dₐ is smaller than Dₘₐₓ;

STEP 106: provide an actual parameter value collection module 60 for collecting the parameter value Pₛₑₙ of the lamp group with a rated current unknown when Dₐ is equal to Dₘₐₓ; and

STEP 107: Provide a maximum dimming parameter and dimming preset parameter value assignment module 70 to assign the product of the parameter value Pₛₑₙ and the actual dimming parameter value Da to the maximum dimming parameter value P_{ref} and assign the maximum dimming parameter value P_{ref} to the dimming preset limit parameter Pₗᵢₘᵢₜ when Dₐ is equal to Dₘₐₓ, and also, to assign the dimming preset limit parameter Pₗᵢₘᵢₜ to the maximum dimming parameter value P_{ref} when Dₐ is smaller than Dₘₐₓ.

Compared with the prior art, since the system 100 for collecting the maximum dimming parameter of a lamp group with a rated current unknown provided by the present invention can timely collect the maximum dimming parameter value P_{ref} of the lamp group with a rated current unknown or varied, so that at any time in the full-scale range dimming is effective, and will not cause the dead zone phenomenon if the dimming parameter value is greater than the dimming range of 70% or 50% of, thereby increasing the user's light experience.

The above disclosure has been described by way of example and in terms of exemplary embodiment, and it is to be understood that the disclosure is not limited thereto. Rather, any modifications, equivalent alternatives or improvement etc. within the spirit of the invention are encompassed within the scope of the invention as set forth in the appended claims.

1. A system for collecting maximum dimming parameters of a lamp group with a rated current unknown, the lamp group includes one lamp operating at a constant voltage or a plurality of lamps connected in parallel, comprising:
a dimming limit parameter and the rated voltage preset module, an actual dimming parameter value collection module, a judgment module, an operating mode switch module, a limit parameter working module, an actual parameter value collection module, and a maximum dimming parameter and a dimming preset parameter value assignment module, the actual dimming parameter value collection module is configured to collect the actual dimming parameter value Dₐ actually loaded into the lamp group with a rated current unknown; the judgment module is configured to judge whether the actual dimming parameter value Dₐ is equal to a full-scale dimming parameter value Dₘₐₓ; the operating mode switching module is configured to make the lamp group with a rated current unknown work at a rated voltage when Dₐ is equal to Dₘₐₓ; the limit parameter working module is configured to make the lamp group with a rated current unknown work at the dimming preset limit parameter Pₗᵢₘᵢₜ when the Dₐ is smaller than Dₘₐₓ; the actual parameter value collection module is configured to collect the parameter value Pₛₑₙ of the lamp group with a rated current unknown when Dₐ is equal to Dₘₐₓ; the maximum dimming parameter and dimming preset parameter value assignment module is configured to assign the product of the parameter value Pₛₑₙ and the actual dimming parameter value Dₐ to the maximum dimming parameter value P_{ref} and assign the maximum dimming parameter value P_{ref} to the dimming preset limit parameter Pₗᵢₘᵢₜ when Dₐ is equal to Dₘₐₓ, and also, to assign the dimming preset limit parameter Pₗᵢₘᵢₜ to the maximum dimming parameter value P_{ref} when Dₐ is smaller than Dₘₐₓ.

2. The system for collecting maximum dimming parameters of a lamp group with a rated current unknown as claimed in claim 1, wherein when the maximum dimming current parameter system and the lamp set with the rated current are electrically connected for the first time, the actual dimming parameter value Dₐ is set to the dimming maximum range value Dₘₐₓ.

3. The system for collecting maximum dimming parameters of a lamp group with a rated current unknown as claimed in claim 1, wherein the preset rated voltage is 24V.

4. The system for collecting maximum dimming parameters of a lamp group with a rated current unknown as claimed in claim 1, wherein before using the maximum dimming parameter collecting system, the total power of the lamp group with rated current unknown is unknown.

5. The system for collecting maximum dimming parameters of a lamp group with a rated current unknown as claimed in claim 1, wherein the system for collecting the maximum dimming parameter of a lamp group with a rated current unknown and the lamp group with unknown rated current are electrically connected for the first time, when the total power of the lamp group with the rated current unknown is reduced, the lamp group with the rated current unknown will be started at the maximum dimming parameter value I_{ref} collected for the first time.

6. The system for collecting maximum dimming parameters of a lamp group with a rated current unknown as claimed in claim 1, wherein the system for collecting the maximum dimming parameter of a lamp group with a rated current unknown and the lamp group with unknown rated current are electrically connected for the first time, when the total power of the lamp group with the rated current unknown increases, the lamp group with the rated current unknown operates at the preset rated voltage.

7. The system for collecting maximum dimming parameters of a lamp group with a rated current unknown as claimed in claim 1, wherein the lamp groups with rated current unknown operate at a constant voltage.

8. A method for collecting maximum dimming parameters of a lamp group with a rated current unknown, comprising the following steps:
provide a dimming preset limit parameter and rated voltage preset module, the dimming preset limit parameter and rated voltage preset module is configured to preset the value of the dimming preset limit parameter Pₗᵢₘᵢₜ and the rated voltage value when the system for collecting the maximum dimming parameter of a lamp group with a rated current unknown is electrically connected with the lamp group with a rated current unknown for the first time;
provide an actual dimming parameter value collection module, the actual dimming parameter value collection module is configured to collect the actual dimming parameter value Dₐ actually loaded into the lamp group with a rated current unknown; provide a judgment module, the judgment module is configured to judge whether the actual dimming parameter value Dₐ is equal to a full-scale dimming parameter value Dₘₐₓ;
provide an operating mode switching module for making the lamp group with a rated current unknown work at a rated voltage when Dₐ is equal to Dₘₐₓ; provide a limit parameter working module for making the lamp group with a rated current unknown work at the dimming preset limit parameter Pₗᵢₘᵢₜ when the Dₐ is smaller than Dₘₐₓ;
provide an actual parameter value collection module for collecting the parameter value Pₛₑₙ of the lamp group with a rated current unknown when Dₐ is equal to Dₘₐₓ; and
provide a maximum dimming parameter and dimming preset parameter value assignment module to assign the product of the parameter value Pₛₑₙ and the actual dimming parameter value Da to the maximum dimming parameter value P_{ref} and assign the maximum dimming parameter value P_{ref} to the dimming preset limit parameter Pₗᵢₘᵢₜ when Dₐ is equal to Dₘₐₓ, and also, to assign the dimming preset limit parameter Pₗᵢₘᵢₜ to the maximum dimming parameter value P_{ref} when Dₐ is smaller than Dₘₐₓ.

9. The method for collecting maximum dimming parameters of a lamp group with a rated current unknown as claimed in claim 8, wherein the system for collecting the maximum dimming parameter of a lamp group with a rated current unknown and the lamp group with unknown rated current are electrically connected for the first time, when the total power of the lamp group with the rated current unknown is reduced, the lamp group with the rated current unknown will be started at the maximum dimming parameter value I_{ref} collected for the first time.

10. The method for collecting maximum dimming parameters of a lamp group with a rated current unknown as claimed in claim 8, wherein the system for collecting the maximum dimming parameter of a lamp group with a rated current unknown and the lamp group with unknown rated current are electrically connected for the first time, when the total power of the lamp group with the rated current unknown increases, the lamp group with the rated current unknown operates at the preset rated voltage.
